(19) United States
(12) Patent Application Publication
(10) Pub. No.: US 2020/0028271 A1
(43) Pub. Date: Jan. 23, 2020

(54) Reconfigurable Metamaterial Apparatus and Methods for Microwave Focusing

(71) Applicant: SPAWAR Systems Center Pacific, San Diego, CA (US)

(72) Inventors: Sara R. Wheeland, San Diego, CA (US); John D. Rockway, San Diego, CA (US); Oren Sternberg, San Diego, CA (US); Israel Perez, Newport, RI (US)

(73) Assignee: United States of America as represented by Secretary of the Navy, San Diego, CA (US)

(21) Appl. No.: 15/654,980

(22) Filed: Jul. 20, 2017

(51) Int. Cl. H01Q 15/02

(52) U.S. Cl. CPC H01Q 15/02

(57) ABSTRACT

A reconfigurable metamaterial apparatus, having a metamaterial structure capable of focusing incoming radiation, the incoming radiation having at least one of a normal incoming radiation and an off-axis incoming radiation. The metamaterial structure has a matrix frame structure and an array of elements disposed in relation to the matrix frame structure. The array has a refractive index gradient profile. Each element has a material with a specific refractive index corresponding to its location in the array; and each element has an alterability feature for facilitating selectively altering its refractive index. The alterability feature has at least one of an interchangeability feature and a tunability feature. The refractive index gradient profile is at least one of tunable and optimizable for at least one parameter of focal stength and frequency, whereby undesirable signals from the incoming radiation are wave-guidable for areal dissipation, and whereby delicate equipment is protectable.

### FEDERALLY-SPONSORED RESEARCH AND DEVELOPMENT

The United States Government has ownership rights in the subject matter of the present disclosure. Licensing inquiries may be directed to Office of Research and Technical Applications, Space and Naval Warfare Systems Center, Pacific, Code 72120, San Diego, Calif., 92152; telephone (619) 553-5118; email: ssc_pac_t2@navy.mil. Reference Navy Case No. 103,838.

### BACKGROUND OF THE INVENTION

### Technical Field

The present disclosure technically relates to metamaterials. Particularly, the present disclosure technically relates to metamaterials for microwave focusing.

### Description of Related Art

In the related art, a metamaterial is a material that is synthesized or developed to have a property that is not found in nature. Metamaterials may involve assemblies of multiple elements fashioned from composite materials, such as metals or plastics. Metamaterials can be arranged in repeating patterns and at scales that are smaller than the wavelengths of the phenomena that such metamaterials are intended to influence. Metamaterials derive their properties from their specifically arranged structures, rather than from their base material properties. A metamaterial's precise shape, geometry, size, orientation, and arrangement may impart smart properties that are capable of manipulating electromagnetic waves by blocking, absorbing, enhancing, or bending such electromagnetic waves, to perform beyond that of conventional materials. Some metamaterials are configured to affect electromagnetic waves or sound waves in a manner that is not possible in bulk materials; and other related art metamaterials exhibit a negative refractive index for particular wavelengths and are referred to as “negative-index” metamaterials. Early research into related art metamaterials involves thin wire arrays having only two variable parameters: wire diameter and spacing. Other early research involves split-ring resonators having two more degrees of design freedom: ring diameter and slit width. Such related art metamaterials operate in the THz regime.

One of the major constraints in related art is that any tunability is limited to use for only one application. Therefore, a need exists for metamaterials that are tunable for a variety of applications.

### SUMMARY OF INVENTION

To address at least the needs in the related art, the present disclosure generally involves a reconfigurable metamaterial apparatus, comprising a metamaterial structure capable of focusing incoming radiation, the incoming radiation comprising at least one of a normal incoming radiation and an off-axis incoming radiation. The metamaterial structure comprises a matrix frame structure and an array of elements disposed in relation to the matrix frame structure. The array comprises a refractive index gradient profile. Each element comprises a material having a specific refractive index corresponding to its location in the array; and each element comprises an alterability feature for facilitating selectively altering its refractive index, the alterability feature comprising at least one of an interchangeability feature and a tunability feature. The refractive index gradient profile is at least one of tunable and optimizable for at least one parameter of focal stength and frequency, whereby undesirable signals from the incoming radiation are wave-guidable for areal dissipation, and whereby delicate equipment is protectable.

### BRIEF DESCRIPTION OF THE DRAWINGS

The above, and other, aspects, features, and benefits of several embodiments of the present disclosure are further understood from the following Detailed Description of the Invention as presented in conjunction with the following several figures of the Drawings.

FIG. 1A is a diagram illustrating a top view of a reconfigurable metamaterial apparatus, comprising a metamaterial structure capable of focusing incoming radiation, in accordance with an embodiment of the present disclosure.

FIG. 1B is a diagram illustrating a perspective view of a reconfigurable metamaterial apparatus, as shown in FIG. 1A, comprising a metamaterial structure capable of focusing incoming radiation, in accordance with an embodiment of the present disclosure.

FIG. 2A is a diagram illustrating a top view of a reconfigurable metamaterial apparatus, comprising a metamaterial structure capable of focusing incoming radiation, in accordance with an alternative embodiment of the present disclosure.

FIG. 2B is a diagram illustrating a perspective view of a reconfigurable metamaterial apparatus, as shown in FIG. 2A, comprising a metamaterial structure capable of focusing incoming radiation, in accordance with an alternative embodiment of the present disclosure.

FIG. 3 is a tabular diagram illustrating a pattern for a gradient index profile having symmetry along both an x-axis and a z-axis, by example only, corresponding to a reconfigurable metamaterial apparatus comprising a metamaterial structure capable of focusing incoming radiation, in accordance with an embodiment of the present disclosure.

FIG. 4 is a tabular diagram illustrating another pattern for a gradient index profile having symmetry along a z-axis, by example only, corresponding to a reconfigurable metamaterial apparatus comprising a metamaterial structure capable of focusing incoming radiation, in accordance with an embodiment of the present disclosure.

FIG. 5A is a graphical diagram illustrating a normal incidence plane wave focusing, corresponding to the gradient index profile having symmetry along both the x-axis and the z-axis, by example only, as shown in FIG. 3, effected by a reconfigurable metamaterial apparatus comprising a metamaterial structure, in accordance with an embodiment of the present disclosure.

FIG. 5B is a graphical diagram illustrating a normal incidence plane wave focusing, corresponding to the gradient index profile having symmetry along the z-axis, by example only, as shown in FIG. 4, effected by a reconfigurable metamaterial apparatus comprising a metamaterial structure, in accordance with an embodiment of the present disclosure.

FIG. 6 is a diagram illustrating a front view of an element in an array of elements as included in a reconfigurable metamaterial apparatus comprising a metamaterial structure, in accordance with an embodiment of the present disclosure.

FIG. 7 is a graphical diagram illustrating a normal incidence plane wave focusing, corresponding to the gradient index profile having a biaxial symmetry, by example only, effected by a reconfigurable metamaterial apparatus comprising a metamaterial structure, in accordance with an embodiment of the present disclosure.

FIG. 8 is a graphical diagram illustrating focal strength as a function of focal position for a normal incidence plane wave focusing, corresponding to the gradient index profile having biaxial symmetry, as shown in FIG. 7, by example only, effected by a reconfigurable metamaterial apparatus comprising a metamaterial structure, in accordance with an embodiment of the present disclosure.

FIG. 9 is a diagram illustrating a perspective view of a high frequency structural simulator (HFSS) model that is used for correlating refractive index with pitch, in relation to operation of a reconfigurable metamaterial apparatus comprising a metamaterial structure, in accordance with an embodiment of the present disclosure.

FIG. 10 is a graphical diagram illustrating refractive index as a function of pitch at various frequencies, in relation to operation of a reconfigurable metamaterial apparatus comprising a metamaterial structure, in accordance with an embodiment of the present disclosure.

FIG. 11 is a three-dimensional graphical diagram illustrating pitch contour, e.g., refractive index as a function of focal position and pitch, corresponding to biaxial symmetry, effected by a reconfigurable metamaterial apparatus comprising a metamaterial structure, in accordance with an embodiment of the present disclosure.

FIG. 12 is a three-dimensional graphical diagram illustrating pitch contour, e.g., refractive index as a function of focal position and pitch, corresponding to uniaxial symmetry, effected by a reconfigurable metamaterial apparatus comprising a metamaterial structure, in accordance with an embodiment of the present disclosure.

FIG. 13 is a graphical diagram illustrating a normal incidence plane wave focusing at an off-center point, corresponding to the gradient index profile having uniaxial symmetry, by example only, effected by a reconfigurable metamaterial apparatus comprising a metamaterial structure, in accordance with an embodiment of the present disclosure.

FIG. 14 is a graphical diagram illustrating focal strength as a function of focal position for a normal incidence plane wave focusing, corresponding to the gradient index profile having uniaxial symmetry, by example only, effected by a reconfigurable metamaterial apparatus comprising a metamaterial structure, in accordance with an embodiment of the present disclosure.

FIG. 15 is a table illustrating comparison various performance values, such as focal strength, for comparison, corresponding to uniaxial symmetry and biaxial symmetry, as effectable by a reconfigurable metamaterial apparatus comprising a metamaterial structure capable of focusing incoming radiation, in accordance with an embodiment of the present disclosure.

FIG. 16A is a flow diagram illustrating a method of fabricating a reconfigurable metamaterial apparatus comprising a metamaterial structure, in accordance with an embodiment of the present disclosure.

FIG. 16B is a flow diagram illustrating detailed substeps in the method of fabricating a reconfigurable metamaterial apparatus comprising a metamaterial structure, as shown in FIG. 16A, in accordance with an embodiment of the present disclosure.

FIG. 17 is a flow diagram illustrating a method of focusing incoming radiation, such as microwave radiation, by way of a reconfigurable metamaterial apparatus comprising a metamaterial structure, in accordance with an embodiment of the present disclosure.

Corresponding reference numerals or characters indicate corresponding components throughout the several figures of the Drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood, elements that are useful or necessary in commercially feasible embodiment are often not depicted in order to facilitate a less obstructed view of these various embodiments of the present disclosure.

### DETAILED DESCRIPTION OF THE EMBODIMENT(S)

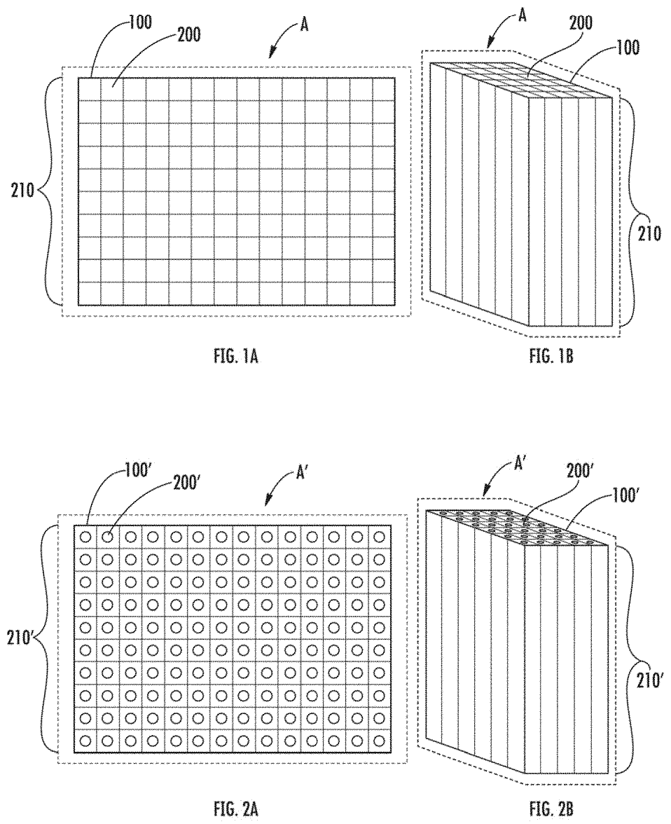

Referring to FIG. 1A, this diagram illustrates, in a top view, a reconfigurable metamaterial apparatus A, comprising a device or metamaterial structure 210 capable of focusing incoming radiation, in accordance with an embodiment of the present disclosure. The incoming radiation comprises at least one of a normal incoming radiation and an off-axis incoming radiation. The metamaterial structure comprises a matrix frame structure 100 and an array of elements 200 disposed in relation to the matrix frame structure 100. The array comprises a refractive index gradient profile. Each element 200 comprises a material having a specific refractive index corresponding to its location in the array; and each element 200 comprises an alterability feature for facilitating selectively altering its refractive index. The alterability feature comprises at least one of an interchangeability feature and a tunability feature, wherein the refractive index gradient profile is at least one of tunable and optimizable for at least one parameter of focal stength and frequency, e.g., the frequency is optimizable in the X-band range, whereby undesirable signals from the incoming radiation are wave-guidable for areal dissipation, and whereby delicate equipment (not shown) is protectable. The interchangeability feature comprises a cell containing the element 200, whereby “swapping” elements 200 from the frame 100 is facilitated, and whereby a need to fabricate another apparatus A in order to achieve the desired focusing is eliminated.

Referring to FIG. 1B, this diagram illustrates a perspective view of a reconfigurable metamaterial apparatus A, as shown in FIG. 1A, comprising a device or metamaterial structure 210 capable of focusing incoming radiation, in accordance with an embodiment of the present disclosure. The interchangeability feature facilitates interchanging each such element with (a) another element comprising one of another element in the array having a different refractive index and (b) any other element having a different refractive index. The tunability feature facilitates reversibly deforming each element 200 by at least one of a mechanical force and an electromotive force. Each element 200 of the array is configured for one of alternating handedness and same handedness, wherein chiral effects are minimizable if each element 200 is configured for alternating handedness, and wherein chiral effects are maximizable if each element 200 is configured for same handedness. In the apparatus A, each element 200 is disposed in the matrix frame structure 100, wherein each element 200 is removable therefrom and interchangeable with (a) any other element 200 in the array having a different refractive index or (b) any other element 200 that is not already in the array that has a different refractive index. The alterability feature of the apparatus A facilitates selectively changing symmetry of the refractive index profile along at least one axis; and the alterability feature facilitates at least one of beam focusing and beam splitting.

Referring to FIG. 2A, this diagram illustrates a top view of a reconfigurable metamaterial apparatus A′, comprising a device or metamaterial structure 210′ capable of focusing incoming radiation, in accordance with an alternative embodiment of the present disclosure. The incoming radiation comprises at least one of a normal incoming radiation and an off-axis incoming radiation. The metamaterial structure comprises a matrix frame structure 100′ and an array of elements 200′ disposed in relation to the matrix frame structure 100′. The array comprises a refractive index gradient profile. Each element 200′ comprises a material having a specific refractive index corresponding to its location in the array; and each element 200′ comprises an alterability feature for facilitating selectively altering its refractive index. The alterability feature comprises at least one of an interchangeability feature and a tunability feature, wherein the refractive index gradient profile is at least one of tunable and optimizable for at least one parameter of focal stength and frequency, e.g., the frequency is optimizable in the X-band range, whereby undesirable signals from the incoming radiation are wave-guidable for areal dissipation, and whereby delicate equipment (not shown) is protectable. The tunability feature comprises either a mechanical actuator or an electrical actuator coupled with each element 200, whereby mechanically altering or electrically altering the elements 200 (by “tweaking”) within the frame 100 is facilitated, and whereby a need to fabricate another apparatus A′ in order to achieve the desired focusing is eliminated.

Referring to FIG. 2B, this diagram illustrates, in a perspective view of a reconfigurable metamaterial apparatus A′, as shown in FIG. 2A, comprising a metamaterial structure capable of focusing incoming radiation, in accordance with an alternative embodiment of the present disclosure. The tunability feature facilitates reversibly deforming each element 200′ by at least one of a mechanical force and an electromotive force. Each element 200′ of the array is configured for one of alternating handedness and same handedness, wherein chiral effects are minimizable if each element 200′ is configured for alternating handedness, and wherein chiral effects are maximizable if each element 200′ is configured for same handedness. The array of elements 200′ is embeddable in the matrix frame structure 100′, wherein a device 210′ comprising a solid composite material, is formable, and wherein each element 200′ of the array remains reversibly deformable. The alterability feature of the apparatus A′ facilitates selectively changing symmetry of the refractive index profile along at least one axis; and the alterability feature facilitates at least one of beam focusing and beam splitting.

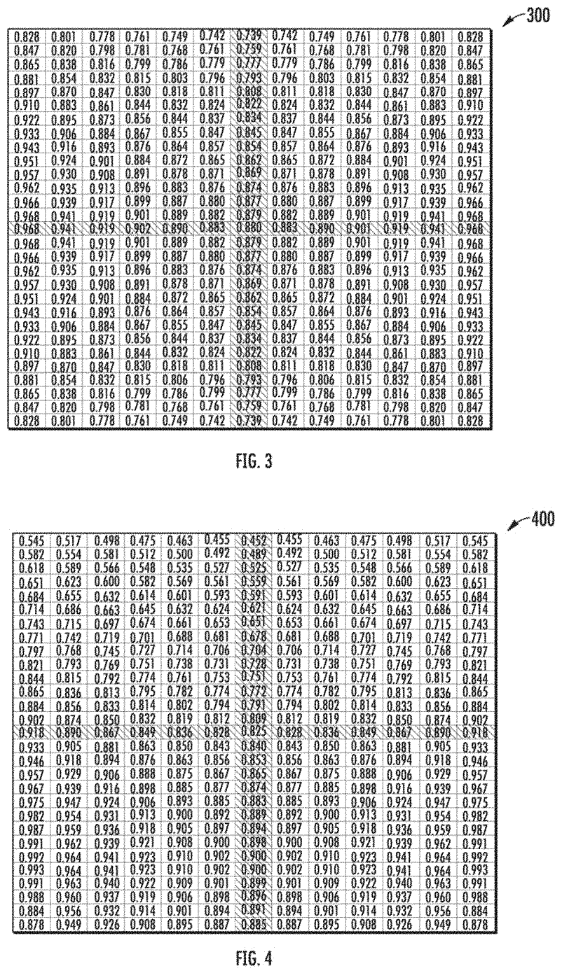

Referring to FIG. 3, this tabular diagram illustrates a pattern 300 for a gradient index profile having symmetry along both an x-axis and a z-axis, by example only, corresponding to a reconfigurable metamaterial apparatus A comprising a metamaterial structure capable of focusing incoming radiation, in accordance with an embodiment of the present disclosure. The reconfigurable metamaterial apparatus A is configured to focus incoming radiation in a manner that results in the pattern 300 by selectively altering, e.g., by interchanging, the at least one element 200.

Referring to FIG. 4, this tabular diagram illustrates another pattern 400 for a gradient index profile having symmetry along a z-axis, by example only, corresponding to a reconfigurable metamaterial apparatus A′ comprising a metamaterial structure capable of focusing incoming radiation, in accordance with an embodiment of the present disclosure. The reconfigurable metamaterial apparatus A′ is configured to focus incoming radiation in a manner that results in the pattern 400 by selectively altering, e.g., by tuning, the at least one element 200′.

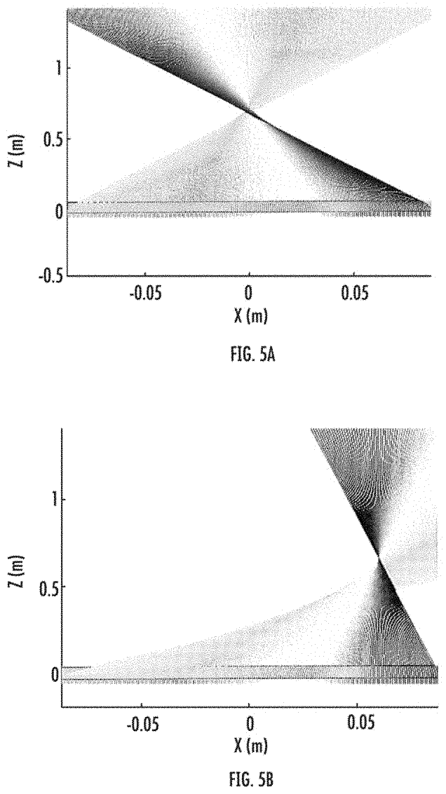

Referring to FIG. 5A, this graphical diagram illustrates a normal incidence plane wave focusing, corresponding to the gradient index profile having symmetry along both the x-axis and the z-axis, by example only, as shown in FIG. 3, effected by a reconfigurable metamaterial apparatus A comprising a metamaterial structure 210, in accordance with an embodiment of the present disclosure.

Referring to FIG. 5B, this graphical diagram illustrates a normal incidence plane wave focusing, corresponding to the gradient index profile having symmetry along the z-axis, by example only, as shown in FIG. 4, effected by a reconfigurable metamaterial apparatus A′ comprising a metamaterial structure 210′, in accordance with an embodiment of the present disclosure.

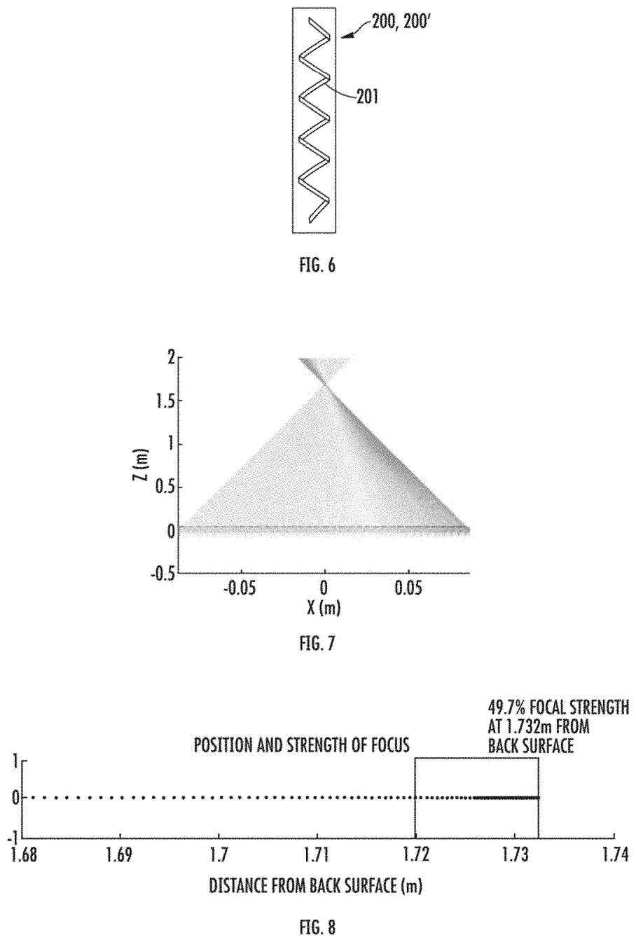

Referring to FIG. 6, this diagram illustrates, in a front view, an element 200 of an array of elements 200 or 200′, as included in a reconfigurable metamaterial apparatus A or A′ comprising a metamaterial structure, in accordance with an embodiment of the present disclosure. Each element 200 or 200′ of the array comprises at least one geometry of a helical configuration 201, a spring configuration, and a material “block” having controlled material properties, by examples only. The helical configuration 201 or the a spring configuration facilitate their selective alteration in refractive index. Selection of a desired alteration to the refractive index of each element 200 or 200′ may be performed by either a user or automatically, e.g., via a feedback and control system and/or artificial intelligence. Each element 200 or 200′ of the array comprises at least one material of a metal, an alloy, a metallic material, a polymeric material, a composite material, a dispersive material, a liquid material, a gaseous material, and a plasma material, by examples only.

Still referring to FIG. 6, the refractive index profile is predeterminable and tunable as a function of a desired focal control, in accordance with some embodiments of the present disclosure. The mechanical force, if used in either the apparatus A or A′, effects reversibly deforming each element 200 or 200′ in any direction by at least one of tensing, straining, compressing, torquing, and bending. The electromotive force, if used in either the apparatus A or A′, may be applied by at least one of a varactor, a variable capacitor, a potentiometer, and a transistor of any kind, and adjusts at least one of permittivity and permeability of each element be effecting a change in at least one of capacitance, inductance, resistance, and voltage. These may be used in conjuction with aforementioned mechanical forces.

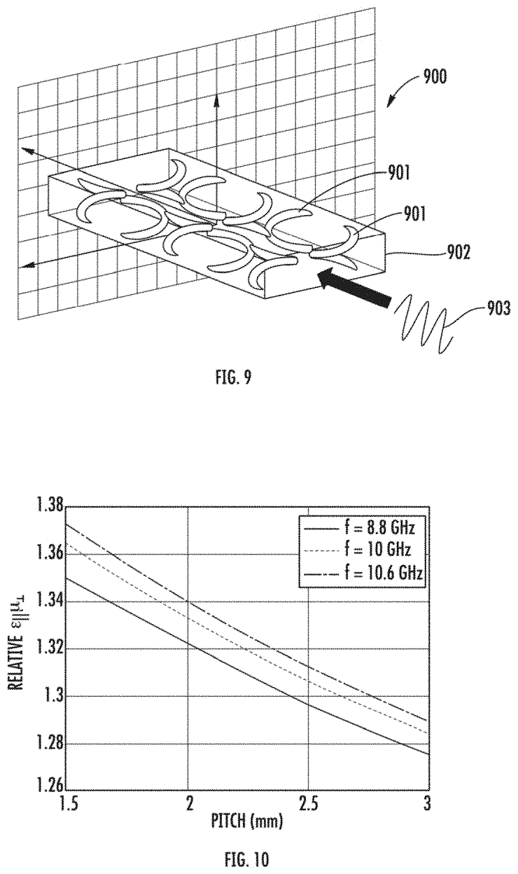

Referring back to FIGS. 1A-6 and ahead to FIGS. 7-15, some apparatuses comprise a metamaterial structure or metamaterial lens having a biaxial symmetry that operates in the microwave X-band frequency range for focusing along a central axis of propagation. However, for applications involving wave direction or energy diversion, focusing off the central axis may be required. The present disclosure involves an apparatus comprising a metamaterial structure having a uniaxial symmetry, e.g., in the direction of propagation. Ray-trace optimization and full-wave finite element simulations are implemented for configuring the metamaterial structure or metamaterial lens. By changing the placement of the focus, further control of the focus parameters is provided, in accordance with embodiments of the present disclosure. While the present disclosure discusses elements having a coil configuration, each element or “unit cell” may comprise any configuration or material.

Still referring back to FIGS. 1A-6 and ahead to FIGS. 7-15, metamaterials are used in the apparatuses of the present disclosure to configure lenses of various types, wherein a user or a processor controls the bulk properties thereof for focusing incident radiation by using a flat surface, rather than a related art curved surface, thereby minimizing spherical aberration, and thereby providing greater control of the focal properties. Various microstructures and various materials are used in the development of gradient index (GRIN) lenses. Such lenses use microstructural elements, such as at least one of split-ring resonators, grooves, or slits to vary magnetic permeability or electric permittivity across the device; and such lenses also use a variety of polymeric and metallic materials.

Still referring back to FIGS. 1A-6 and ahead to FIGS. 7-15, the present disclosure also encompasses an off-axis method for configuring a gradient index for a lens or lenses, e.g., the reconfigurable apparatuses, including methods for optimizing and fabricating such lens or lenses. The present disclosure discusses biaxial symmetry, e.g., about the x-axis and the z-axis, as well as uniaxial symmetry, e.g., about the z-axis. For some embodiments of the present disclosure, the reconfigurable apparatus comprises a metamaterial structure having an array of elements, wherein each element comprises a coiled wire that functions as a reconfigurable physical lens with the addition of pitch as a performance control. Deformation, whether elastic or plastic, of the coils translates to an effective change in refractive index, thereby allowing for mechanical tuning of the metamaterial structure. While fabrication of the reconfigurable apparatus is facilitated by the use of coils as elements in the array, the apparatus and methods of the present disclosure also encompass other configurations for the elements, such as split-ring resonators.

### Ray-Trace Optimization

Referring to FIG. 7, this graphical diagram illustrates a normal incidence plane wave focusing, corresponding to the gradient index profile having biaxial symmetry, by example only, as effected by a reconfigurable metamaterial apparatus comprising a metamaterial structure functioning as a GRIN lense that has been optimized, in accordance with an embodiment of the present disclosure. Configuring a reconfigurable metamaterial apparatus, comprising a metamterial structure capable of functioning as a lens, involves using a Hamiltonian ray-trace optimization analysis, wherein the optimal refractive index gradient profile is determined, or predetermined, for a given set of constraints, such as for a desired application in the field, and wherein such constraints account for the properties of the materials used in the metamaterial structure as well as the desired frequency range.

Still referring to FIG. 7 and ahead to FIG. 16, a method M1 of fabricating a reconfigurable metamaterial apparatus comprises providing a metamaterial structure, wherein providing the metamaterial structure comprises initially configuring the metamaterial structure, in accordance with some embodiments of the present disclosure. Initially configuring the metamaterial structure comprises performing a variety of calculations, such as via a processor operable by a set of executable instructions that are storable in relation to a nontransient memory device, wherein the set of executable instructions comprises an instruction for iteratively solving a set of initial equations in relation to a given set of constraints, such as a set of boundary conditions, e.g., a certain size, a certain material, and a certain distance, corresponding to each air-material interface for maximizing the focal strength. Iteratively solving the set of initial equations commences by considering the eikonal equation:

ME=0, (1)

wherein E is the electric field, and wherein M relates the wave vector, k, the permittivity ε, and the permeability μ. M is expressed as follows:

$$M = k \times k ( \frac{1}{μ} ) + ɛ . \qquad ( 2 )$$

Still referring to FIG. 7 and ahead to FIG. 16, iteratively solving the set of initial equations further comprises considering the Hamiltonian equation being defined as the determinant of M. Assuming that the element in the array comprises a uniaxial dielectric material that is uniform in the y-direction with a nonzero E-field along the y-axis, the Hamiltonian equation is reduced as follows:

H=(kₓ²+k_{z}²−ε_{∥}μ_{⊥})k₀. (3)

Still referring to FIG. 7 and ahead to FIG. 16, iteratively solving the set of initial equations further comprises rewriting the Hamiltonian equation to express that the phase change accumulates along the path of the incoming ray or radiation, as follows:

$$\begin{matrix}\frac{dr}{d φ} = \pm \frac{{∇}_{k} {H}_{e}}{\vert {∇}_{k} {H}_{e} \vert \vert k \vert} and & ( 4 ) \\ \frac{dk}{d φ} = ∓ \frac{{∇}_{r} {H}_{e}}{\vert {∇}_{k} {H}_{e} \vert \vert k \vert} . & ( 5 )\end{matrix}$$

Still referring to FIG. 7 and ahead to FIG. 16, iteratively solving the set of initial equations further comprises calculating the refractive index as a function of position as follows:

$${ɛ}_{‖} {μ}_{⊥} = c ( 1 - \frac{{x}^{2}}{{a}_{x}} + \frac{{z}^{2}}{{a}_{z}} ) . \qquad ( 6 )$$

wherein c, aₓ, and a_{z} are constants.

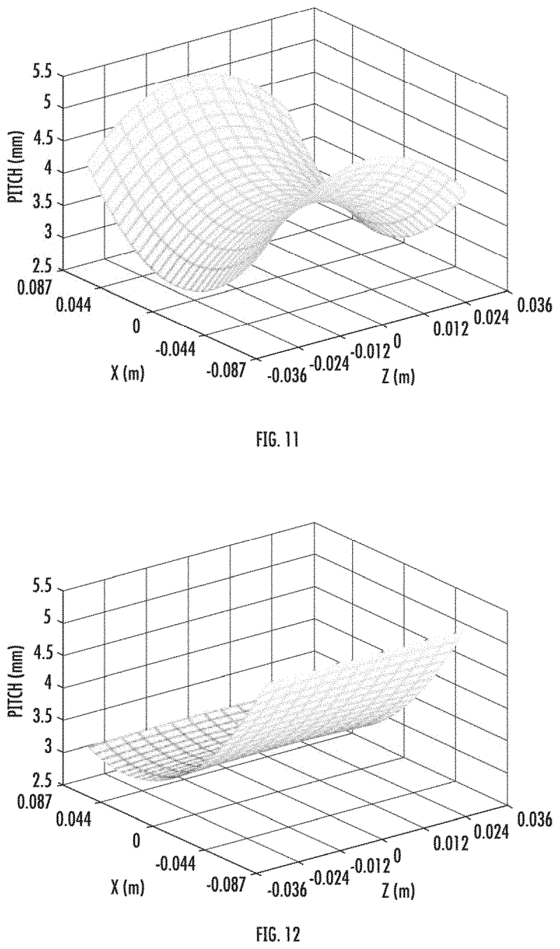

Referring to FIG. 8, this graphical diagram illustrates focal strength as a function of focal position for a normal incidence plane wave focusing, corresponding to the gradient index profile having biaxial symmetry, as shown in FIG. 7, by example only, as effected by a reconfigurable metamaterial apparatus, such as the apparatus A or A′, comprising a metamaterial structure, such as the structure 210 or 210′, in accordance with an embodiment of the present disclosure. The strength and location of the focus as calculated by the processor iteratively solving the set of initial equations is shown in FIG. 8.

### Simulation and Configuration

Referring to FIG. 9 and ahead to FIG. 16, this diagram illustrates, in a perspective view, an HFSS model 900 that is used for correlating refractive index with pitch, in relation to operation of a reconfigurable metamaterial apparatus, such as the apparatus A or A′, comprising a metamaterial structure, such as the structure 210 or 210′, in accordance with an embodiment of the present disclosure. In the method M1 of fabricating the the apparatus A or A′, providing a metamaterial structure, e.g., the structure 210 or 210′, further comprises generating a HFSS model 900 comprising at least one semi-infinite five-layer model by using a finite element method solver, thereby providing at least one full-wave simulation, e.g., based on at least one incoming ray 903, corresponding to the at least one semi-infinite five-layer model; and analyzing each at least one full-wave simulation, thereby characterizing a relationship between the refractive index of an optimized homogeneous metamaterial structure and an existing physical metamaterial structure, thereby providing configuring data, or reconfiguring data, such as a desired pitch value corresponding to each point (or cell) within an array of elements, e.g., the coils, and thereby facilitating fabrication of the reconfigurable apparatus. The HFSS model comprises five layers of unit cells having alternating handedness for minimizing chiral effects. Each unit cell comprises a model element 901, and a model frame 902.

Referring to FIG. 10 and ahead to FIG. 16, this graphical diagram illustrates refractive index as a function of pitch at various frequencies, in relation to operation of a reconfigurable metamaterial apparatus, such as the apparatus A or A′, comprising a metamaterial structure, such as the structure 210 or 210′, in accordance with an embodiment of the present disclosure. In the method M1 of fabricating the the apparatus A or A′, providing a metamaterial structure, e.g., the structure 210 or 210′, further comprises varying pitch in a range of approximately 1.5 mm to approximately 3.0 mm. Providing a metamaterial structure, e.g., the structure 210 or 210′, further comprises extracting a material property of interest from an S-matrix by using a “Ghodgaonkar” technique. Within a residual norm of 0.0045, the pitch of a brass wire, by example only, is linearly proportional to the refractive index. Providing a metamaterial structure further comprises determining the pitch from the optimized gradient profile by analyzing the results after applying the “Ghodgaonkar” technique. The step of varying pitch may also be performed for specific frequency ranges as well as for specific frequencies.

Still referring to FIG. 10 and ahead to FIG. 16, in applying the “Ghodgaonkar” technique, the permittivity and the permeability of the material block are assumed and edge effects are assumed neglected. For S-parameters that are measured by using de-embedded reference planes, e.g., planes that are not coincident with the surface of the material block, a phase correction is made in accounting for the additional air in the apparatus. The phase correction or phase shift is related to the length of air volume on either side of the material block and to the propagation constant of free space. The corrected values for S₁₁ and S₂₁, assuming the same de-embedded length on either side of the material block, are calculated by using the following equations:

s₁₁=e⁻²^{_{πfl}}Sⁱ₁₁ and (7)

S₂₁=(e⁻²^{_{πfl}})²Sⁱ₂₁, (8)

wherein f is the frequency, wherein l is the length of air volume, and wherein i indicates an initial S-parameter value. These parameters can then be related to the reflection and transmission coefficients through the following expressions:

S₁₁=[(1−T²)]/(1−Γ²T²) and (9)

S₂₁=[(1−Γ²)]/(1−Γ²T₂). (10)

Still referring to FIG. 10 and ahead to FIG. 16, in applying the “Ghodgaonkar” technique, for a material block having a length d with a characteristic impedance Z and a propagation constant γ, the reflection and transmission coefficients are given by the following expressions:

Γ=(Z−1)/(Z+1) and (11)

T=e^{-γd}. (12)

Both Z and γ depend on the relative permittivity and permeability of the medium as found via the following expressions:

Z=√ε/μand (13)

γ=γ₀√εμ, (14)

wherein γ₀ is the propagation constant of free space equal to j2π/λ₀, wherein λ₀ is the free space wavelength, and wherein j=√−1.

Still referring to FIG. 10 and ahead to FIG. 16, in applying the “Ghodgaonkar” technique, by using the foregoing expressions (7) through (14), the reflection and transmission coefficients can be rewritten as:

Γ=K±√K²−1, wherein K=(S²₁₁−S²₂₁+1)/2S₁₁ and (15)

T=(S₁₁+S₂₁−Γ)/[1−(S₁₁+S₂₁)Γ], wherein the sign for Γ is such that |Γ|<1. (16)

By using the following relation:

√ε/μ=(1+Γ)/(1−Γ), (17)

the permittivity and the permeability can be expressed as functions of γ and Γ as follows:

ε=(γ/γ₀)[(1−Γ)/(1+Γ)] and (18)

μ=(γ/γ⁰)[(1+Γ)/(1−Γ)]. (19)

If T=|T|e^{lφ} is set, the propagation constant is expressed as follows:

γ=ln(1/|T|)/d+j[(2πn−φ)/d], f or n=0, ±1, ±2, . . . (20)

Referring to FIG. 11, this three-dimensional graphical diagram illustrates pitch contour, e.g., refractive index as a function of focal position and pitch, corresponding to biaxial symmetry, as effected by a reconfigurable metamaterial apparatus, such as the apparatus A or A′, comprising a metamaterial structure, such as the structure 210 or 210′, in accordance with an embodiment of the present disclosure. As the pitch increases, the refractive index decreases (inversely proportional). For a biaxially symmetric structure, the maximum refractive index is obtained at the center of the material, e.g., the metamaterial; whereas the maximum pitch value occurs at extreme locations in the x-directions in relation to the z-axis of symmetry and as per the following expression:

$$\frac{max ( {ɛ}_{‖} {μ}_{⊥} ) - min ( {ɛ}_{‖} {μ}_{⊥} )}{min ( {ɛ}_{‖} {μ}_{⊥} )} ∝ \frac{max ( pitch ) - min ( pitch )}{min ( pitch )} . \qquad ( 7 )$$

The final configuration or “mapping” for the metamaterial structure comprises a refractive index value and a pitch value at each point (or cell) within the array of elements. From this “mapping” or layout, the elements, e.g., the coils are physically fabricated; and the overall lens or metamaterial structure is fabricated. For example, a biaxially symmetric metamaterial structure, e.g., a brass device, is configured to focus approximately 50% of the normally incident parallel plane waves by using the initial configuration.

### Uniaxially Symmetric Focusing

Referring to FIG. 12, this three-dimensional graphical diagram illustrating pitch contour, e.g., refractive index as a function of focal position and pitch, corresponding to uniaxial symmetry, as effected by a reconfigurable metamaterial apparatus, such as the apparatus A or A′, comprising a metamaterial structure, such as the structure 210 or 210′, in accordance with an embodiment of the present disclosure. The ability to control the direction and intensity of wave propagation by the reconfigurable appratus allows for greater flexibility in the metamaterial structure configuration and application. The foreoing configuration techniques are also applicable to a uniaxially symmetric GRIN lens. With biaxial symmetry, the highest index occurs at the center of the device or the metamaterial structure, wherein ε_{|}μ_{⊥} reaches its maximum value along an off-center line, with symmetry being along the direction of propagation, e.g., in the z-direction. FIG. 12 shows the pitch contour for the uniaxially symmetric lens, device, or the metamaterial structure, wherein the maximum pitch occurs along the lowest x-value.

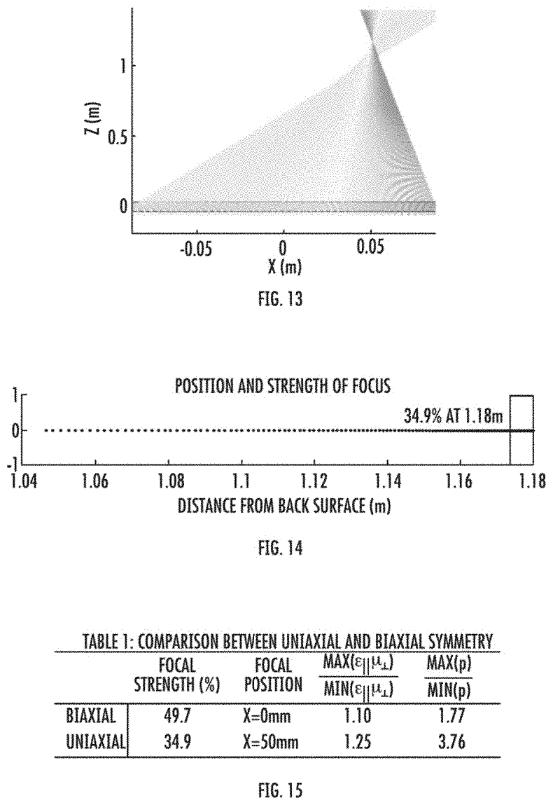

Referring to FIG. 13, this graphical diagram illustrates a normal incidence plane wave focusing at an off-center point, corresponding to the gradient index profile having uniaxial symmetry, by example only, as effected by a reconfigurable metamaterial apparatus, such as the apparatus A or A′, comprising a metamaterial structure, such as the structure 210 or 210′, in accordance with an embodiment of the present disclosure. An element, such as the element 200 or 200′, comprising a material with such uniaxial symmetry, focuses incident plane waves at an off-center point. By changing the refractive index symmetry, the location and strength of the focus is changed by the reconfigurable apparatus.

Referring to FIG. 14, this graphical diagram illustrates focal strength as a function of focal position for a normal incidence plane wave focusing, corresponding to the gradient index profile having uniaxial symmetry, by example only, as effected by a reconfigurable metamaterial apparatus, such as the apparatus A or A′, comprising a metamaterial structure, such as the structure 210 or 210′, in accordance with an embodiment of the present disclosure. In this embodiment, metamaterial structure operates as a uniaxially symmetric GRIN lens.

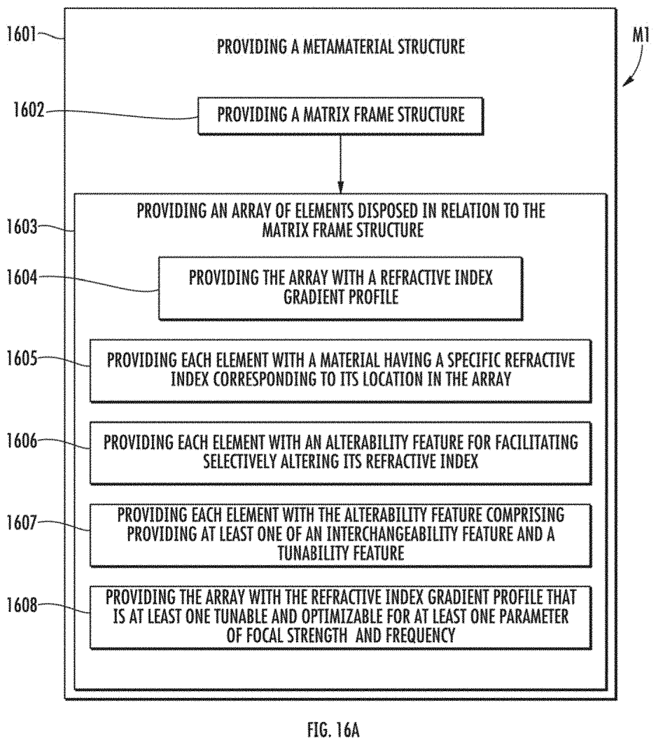

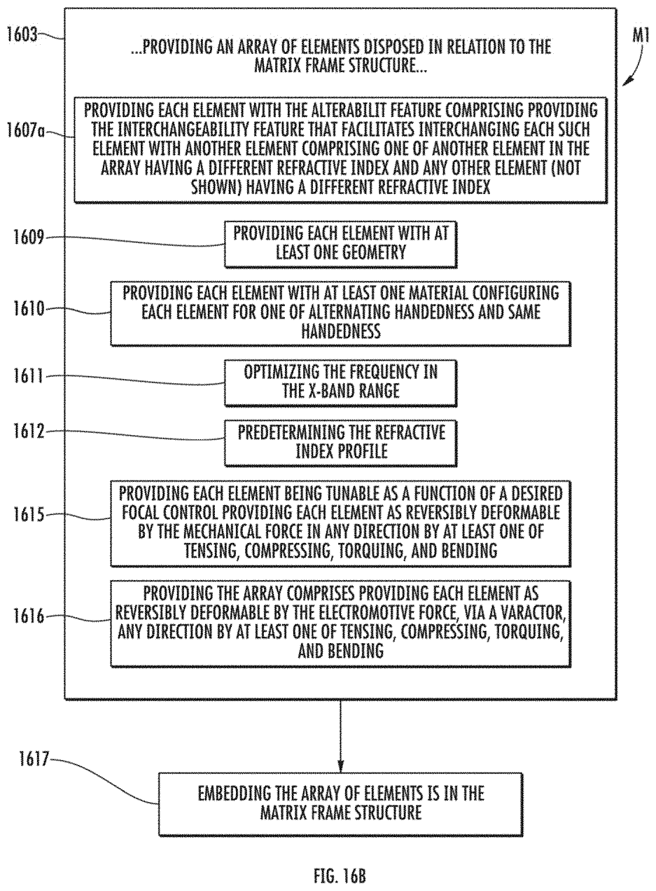

Referring to FIG. 15, this table illustrates comparison various performance values, such as focal strength, for comparison, corresponding to uniaxial symmetry and biaxial symmetry, as effectable by a reconfigurable metamaterial apparatus, such as the apparatus A or A′, comprising a metamaterial structure, such as the structure 210 or 210′, capable of focusing incoming radiation, in accordance with an embodiment of the present disclosure. Relative to the biaxially symmetric structure, the uniaxially symmetric structure provides further wave control and configuration, and reconfiguration, flexibility, without significantly diminishing focal strength, the approximate relative values of which are shown in FIG. 15. Also, relative to the biaxially symmetric structure, the uniaxially symmetric structure has a greater difference (greater refractive index value spread) between the maximum refractive index value and the minimum refractive index value across the material, whereby the greater refractive index value spread facilitates fabrication of the metamaterial structure.

Referring to FIG. 16A, this flow diagram illustrates a method M1 of fabricating a reconfigurable metamaterial apparatus, such as the apparatus A or A′, comprising a metamaterial structure, such as the structure 210 or 210′, capable of focusing incoming radiation, in accordance with an embodiment of the present disclosure. The method M1 comprises: providing a metamaterial structure, such as the structure 210 or 210′, capable of focusing incoming radiation, the incoming radiation comprising at least one of a normal incoming radiation and an off-axis incoming radiation, as indicated by block 1601, providing the metamaterial structure comprising: providing a matrix frame structure, as indicated by block 1602; and providing an array of elements disposed in relation to the matrix frame structure, as indicated by block 1603, providing the array comprising providing the array with a refractive index gradient profile, as indicated by block 1604, providing the array comprising providing each element with a material having a specific refractive index corresponding to its location in the array, as indicated by block 1605, and providing the array comprising providing each element with an alterability feature for facilitating selectively altering its refractive index, as indicated by block 1606, providing each element with the alterability feature comprising providing at least one of an interchangeability feature and a tunability feature, as indicated by block 1607, wherein providing the array comprises providing the array with the refractive index gradient profile that is at least one of tunable and optimizable for at least one parameter of focal stength and frequency, as indicated by block 1608, whereby undesirable signals from the incoming radiation are wave-guidable for areal dissipation, and whereby delicate equipment is protectable.

Referring to FIG. 16B, this flow diagram illustrates detailed substeps in the method M1 of fabricating a reconfigurable metamaterial apparatus A or A′ comprising a metamaterial structure 210 or 210′, as shown in FIG. 16A, in accordance with an embodiment of the present disclosure. In the method M1, providing each element with the alterability feature, as indicated by block 1607, comprises providing the interchangeability feature that facilitates interchanging each such element 200 or 200′ with another element comprising one of another element 200 or 200′ in the array having a different refractive index and any other element (not shown) having a different refractive index, as indicated by block 1607a. Providing the tunability feature facilitates reversibly deforming each element by at least one of a mechanical force and an electromotive force. Providing the alterability feature facilitates selectively changing symmetry of the refractive index profile along at least one axis. Providing the alterability feature facilitates at least one of beam focusing and beam splitting. Providing the array comprises providing each element with at least one geometry of a helical configuration, a spring configuration, and a material “block” with controlled material properties, as indicated by block 1609. Providing the array comprises providing each element with at least one material of a metal, an alloy, a metallic material, a polymeric material, a composite material, a dispersive material, a liquid material, a gaseous material, and a plasma material, as indicated by block 1610.

Still referring to FIG. 16B, in the method M1, providing the array comprises configuring each element for one of alternating handedness and same handedness, as indicated by block 1611, whereby chiral effects are minimizable if providing the array comprises configuring each element for alternating handedness, and whereby chiral effects are maximizable if providing the array comprises configuring each element for same handedness. In the method M1, providing the apparatus A or A′ comprises optimizing the frequency in the X-band range, as indicated by block 1611. Providing the array comprises predetermining the refractive index profile, as indicated by block 1612, and providing each element being tunable as a function of a desired focal control, as indicated by block 1615. Providing the array comprises providing each element as reversibly deformable by the mechanical force in any direction by at least one of tensing, straining, compressing, torquing, and bending, as indicated by block 1615. Providing the array comprises providing each element as reversibly deformable by the electromotive force, via at least one of a varactor, a variable capacitor, a potentiometer, and a transistor of any kind, by adjusting at least one of permittivity and permeability of each element by effecting a change in at least one of capacitance, inductance, resistance, and voltage, possibly in conjunction with aforementioned mechanical force, as indicated by block 1616. The method M1 further comprises embedding the array of elements 200′ is in the matrix frame structure 100′, as indicated by block 1617, thereby forming a composite material 210′, such as a least one of a solid composite material and a semi-solid composite material (FIG. 2B), and wherein each element 200′ of the array remains reversibly deformable, either mechanically or electromagnetically, in accordance with an alternative embodiment of the present disclosure.

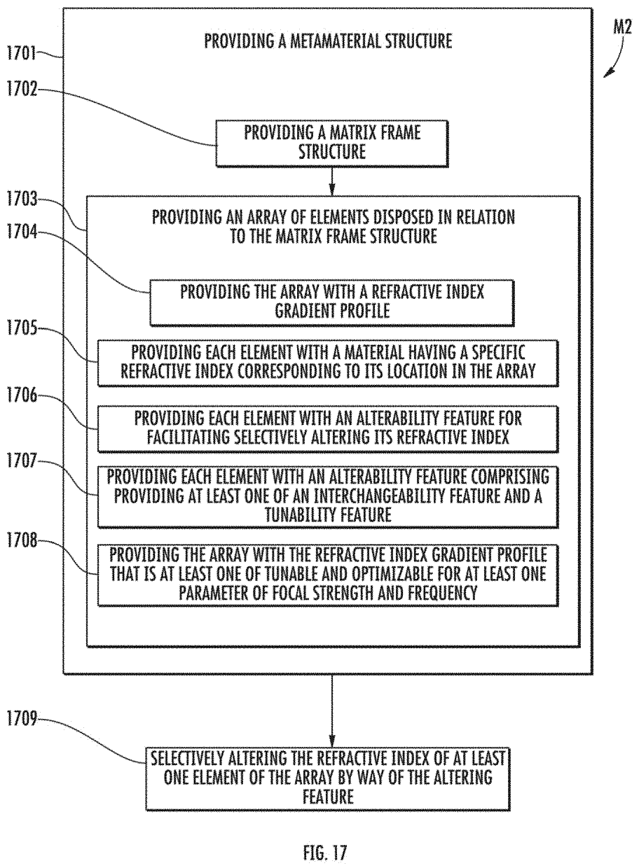

Referring to FIG. 17, this flow diagram illustrates a method M2 of of focusing waves by way of a reconfigurable metamaterial apparatus, such as the apparatus A or A′, in accordance with an embodiment of the present disclosure. The method M2 comprises: providing the reconfigurable metamaterial apparatus, as indicated by block 1701, providing the reconfigurable metamaterial comprising providing a metamaterial structure capable of focusing incoming radiation, the incoming radiation comprising at least one of a normal incoming radiation and an off-axis incoming radiation, as indicated by block 1701, providing the metamaterial structure comprising: providing a matrix frame structure, as indicated by block 1702; and providing an array of elements disposed in relation to the matrix frame structure, as indicated by block 1703, providing the array comprising providing the array with a refractive index gradient profile, as indicated by block 1704, providing the array comprising providing each element with a material having a specific refractive index corresponding to its location in the array, as indicated by block 1705, and providing the array comprising providing each element with an alterability feature for facilitating selectively altering its refractive index, as indicated by block 1706, providing each element with the alterability feature comprising providing at least one of an interchangeability feature and a tunability feature, as indicated by block 1707, wherein providing the array comprises providing the array with the refractive index gradient profile that is at least one of tunable and optimizable for at least one parameter of focal strength and frequency, as indicated by block 1708, whereby undesirable signals from the incoming radiation are wave-guidable for areal dissipation, and whereby delicate equipment is protectable; selectively altering the refractive index of at least one element of the array by way of the altering feature, as indicated by block 1709, thereby at least one of tuning and optimizing the refractive index profile, and thereby wave-guiding the undesirable signals from the incoming radiation for areal dissipation, and thereby protecting delicate equipment.

Referring back to FIGS. 1A-17, the present disclosure encompasses apparatuses and methods for configuring a metamaterial structure for operation as a GRIN lens that is optimized for maximum focal strength and capable of providing both biaxial symmetry and uniaxial symmetry. The optimization techniques of the present disclosure comprise using a Hamiltonian ray-trace formulation that includes an accumulated phase. Additionally, the optimization techniques of the present disclosure comprise using full-wave simulations for relating properties of the theoretical structure to those of a physical structure, e.g., a lens. The physical properties are then applicable in constructing the physical structure, e.g., the lens. Although some focal strength is sacrificed by using the uniaxially symmetric lens instead of a biaxially symmetric lens, flexibility in the configuration and the ability to further control the location of the focus is enhanced while spherical aberration is also minimized.

It is understood is that many additional changes in the details, materials, steps and arrangement of parts, which have been herein described and illustrated to explain the nature of the invention, may be made by those skilled in the art within the principle and scope of the invention as expressed in the appended claims.

What is claimed:

1. A reconfigurable metamaterial apparatus, comprising:
a matrix frame structure; and
an array of elements , each element comprising a material having a specific refractive index corresponding to its location in the array,
wherein the refractive index gradient profile is tunablefor one parameter of focal stength and frequency.

2. The apparatus of claim 1, further comprising,
an interchangeability feature that facilitates interchanging any such element with another element comprising one of another element in the array having a different refractive index and any other element having a different refractive index.

3. The apparatus of claim 2, further comprising,
an alterability feature that facilitates selectively changing symmetry of the refractive index profile along at least one axis.

4. The apparatus of claim 1, wherein each element of the array comprises at least one geometry of a helical configuration, a spring configuration, and a material “block” having controlled material properties.

5. The apparatus of claim 1, wherein each element of the array comprises at least one material of a metal, an alloy, a metallic material, a polymeric material, a composite material, a dispersive material, a liquid material, a gaseous material, and a plasma material.

6. The apparatus of claim 1,
wherein each element of the array is configured for one of alternating handedness and same handedness, and
wherein chiral effects are minimizable if each element is configured for alternating handedness, and
wherein chiral effects are maximizable if each element is configured for same handedness.

7. The apparatus of claim 1, wherein the array of elements is optimizable for frequency in an X-band range.

8. The apparatus of claim 2,
wherein the refractive index profile is predetermined and tunable as a function of a desired focal control, and
wherein a mechanical force effects reversibly deforming each element in any direction by at least one of tensing, straining, compressing, torquing, and bending.

9. The apparatus of claim 2,
wherein the refractive index profile is predetermined and tunable as a function of a desired focal control, and an electromotive force,
wherein the electromotive force, by way of at least one of a varactor, a variable capacitor, a potentiometer, and a transistor of any kind, adjusts at least one of permittivity and permeability of each element by effecting a change in at least one of capacitance, inductance, resistance and voltage.

10. The apparatus of claim 1,
wherein the array of elements is embeddable in the matrix frame structure, and
wherein a solid composite material is formable, and
wherein each element of the array remains reversibly deformable.

11. A method of fabricating a reconfigurable metamaterial apparatus, comprising:
providing a metamaterial structure capable of focusing incoming radiation, the incoming radiation comprising at least one of a normal incoming radiation and an off-axis incoming radiation, providing the metamaterial structure comprising:
providing a matrix frame structure; and
providing an array of elements disposed in relation to the matrix frame structure, providing the array comprising providing the array with a refractive index gradient profile, providing the array comprising providing each element with a material having a specific refractive index corresponding to its location in the array, and providing the array comprising providing each element with an alterability feature for facilitating selectively altering its refractive index, providing each element with the alterability feature comprising providing at least one of an interchangeability feature and a tunability feature,
wherein providing the array comprises providing the array with the refractive index gradient profile that is at least one of tunable and optimizable for at least one parameter of focal stength and frequency, whereby undesirable signals from the incoming radiation are wave-guidable for areal dissipation, and whereby delicate equipment is protectable.

12. The method of claim 11,
wherein providing the interchangeability feature facilitates interchanging each such element with another element comprising one of another element in the array having a different refractive index and any other element having a different refractive index, and
wherein providing the tunability feature facilitates reversibly deforming each element by at least one of a mechanical force and an electromotive force.

13. The method of claim 11,
wherein providing the alterability feature facilitates selectively changing symmetry of the refractive index profile along at least one axis, and
wherein providing the alterability feature facilitates at least one of beam focusing and beam splitting.

14. The method of claim 11, wherein providing the array comprising providing each element with at least one geometry of a helical configuration, a spring configuration, and a material block having at least one controlled material property.

15. The method of claim 11, wherein providing the array comprises providing each element with at least one material of a metal, an alloy, a metallic material, a polymeric material, a composite material, a dispersive material, a liquid material, a gaseous material, and a plasma material.

16. The method of claim 11,
wherein providing the array comprises configuring each element for one of alternating handedness and same handedness, and
whereby chiral effects are minimizable if providing the array comprises configuring each element for alternating handedness, and
whereby chiral effects are maximizable if providing the array comprises configuring each element for same handedness.

17. The method of claim 11, wherein providing the array of elements comprises optimizing the array for frequency in an X-band range.

18. The method of claim 12,
wherein providing the array comprises predetermining the refractive index profile and providing each element being tunable as a function of a desired focal control, and
wherein providing the array comprises providing each element as reversibly deformable by the mechanical force in any direction by at least one of tensing, straining, compressing, torquing, and bending, and
wherein providing the array comprises providing each element as reversibly deformable by the electromotive force, via at least one of a varactor, a variable capacitor, a potentiometer, and a transistor of any kind, and adjusts a permittivity or permeability of the material through changes in capacitance, inductance, resistance and/or voltage.

19. The method of claim 12, further comprising embedding the array of elements is in the matrix frame structure, thereby forming a solid composite material, and wherein each element of the array remains reversibly deformable.

20. A method of focusing waves by way of a reconfigurable metamaterial apparatus, comprising:
providing the reconfigurable metamaterial apparatus, providing the reconfigurable metamaterial comprising providing a metamaterial structure capable of focusing incoming radiation, the incoming radiation comprising at least one of a normal incoming radiation and an off-axis incoming radiation, providing the metamaterial structure comprising:
providing a matrix frame structure; and
providing an array of elements disposed in relation to the matrix frame structure, providing the array comprising providing the array with a refractive index gradient profile, providing the array comprising providing each element with a material having a specific refractive index corresponding to its location in the array, and providing the array comprising providing each element with an alterability feature for facilitating selectively altering its refractive index, providing each element with the alterability feature comprising providing at least one of an interchangeability feature and a tunability feature,
wherein providing the array comprises providing the array with the refractive index gradient profile that is at least one of tunable and optimizable for at least one parameter of focal stength and frequency, whereby undesirable signals from the incoming radiation are wave-guidable for areal dissipation, and whereby delicate equipment is protectable;
selectively altering the refractive index of at least one element of the array by way of the altering feature, thereby at least one of tuning and optimizing the refractive index profile, and thereby wave-guiding the undesirable signals from the incoming radiation for areal dissipation, and thereby protecting delicate equipment.
